(19) United States
(12) Patent Application Publication
(10) Pub. No.: US 2009/0229391 A1
(43) Pub. Date: Sep. 17, 2009

(54) MECHANICAL POWER TRANSFER DEVICE

(76) Inventor: David S. Eakin, San Bernardino, CA (US)

Correspondence Address: CONNOLLY BOVE LODGE & HUTZ, LLP, P O BOX 2207, WILMINGTON, DE, 19899, US

(21) Appl. No.: 12/046,811

(22) Filed: Mar. 12, 2008

(51) Int. Cl. F16H 29/02

(52) U.S. Cl. 74/117

(57) ABSTRACT

A power coupling device is disclosed. The device comprises a dive input, a drive output, a spur gear, and a worm. The spur gear is coupled to one of the drive input and the drive output, and the worm is coupled to the other of the drive input and the drive output. Power is transferred between the drive input and the drive output through the spur gear and the worm. During operation, the worm engages the spur gear such that when the worm is rotated, no power is transferred through the worm, and when the worm is translated without rotation, power is transferred through the worm.

### BACKGROUND OF THE INVENTION

1. Field of the Invention

The field of the present invention is mechanical systems for power transfer, such as clutches and transmissions.

2. Background

The “worm gear”, commonly referred to simply as a “worm”, has a very long history. The name comes from the spiral, worm-like grove traversing almost the entire functional surface. Over the centuries, the design and use of the worm has evolved and improved. Today, the worm enjoys many varied applications-from power transmissions to manufacturing. However, for all the applications in which the worm is employed, the worm is generally found rotationally engaging a spur gear for purposes of high ratio gear reduction or for transferring power between shafts at right angles. In such applications, the worm is capable of driving high loads, and it may be designed to be back-drivable or to resist back-drive through locking engagement with the spur gear. A lesser used secondary function of the worm is to use it and the spur gear in combination as a rack and pinion. Such a use is described in U.S. Pat. No. 1,940,101, in which the worm has two modes, it does work while rotating through its engagement with the spur gear, and it does work while translating, performing as a rack and pinion with the spur gear. What follows builds upon this lesser used mode of operation.

### SUMMARY OF THE INVENTION

The present invention is directed toward a device for transferring mechanical power. An input drive is coupled to an output drive through a worm and a spur gear, the worm being coupled to one of the input drive or the output drive, and the spur gear being coupled to the other. Power from the input drive is transferred to the output drive through the worm and the spur gear. The worm engages the spur gear such that when the worm is rotated, no power is transferred from the worm to the spur gear, and when the worm is translated without rotation, power is transferred from the worm to the spur gear. In this manner, the input drive may be used to intermittently power the output drive using a single worm and spur gear. Preferably, when the worm is translated without rotation, the worm and spur gear perform as a rack and pinion, and the worm moves the spur gear in the forward direction. Also, when the worm rotates, the worm preferably rotates in the reverse direction and simultaneously translates in the reverse direction. Additional worms may be added, with or without additional spur gears, to constantly power the drive output.

When the worm is rotated in the reverse direction, it is rotated at a rate which permits the spur gear to remain stationary or to continue rotating in the forward direction. A coupling may link the worm to one of the drive input or the drive output to rotate the worm in the reverse direction. The coupling may comprise a coil spring adapted to be tensioned and rotate the worm upon release, or the coupling may comprise two gears and a cam adapted to periodically engage one gear with the other such that when the gears engage, the worm is rotated.

Accordingly, an improved device for transferring mechanical power is disclosed. Advantages of the improvements will appear from the drawings and the description of the preferred embodiment.

### BRIEF DESCRIPTION OF THE DRAWINGS

In the drawings, wherein like reference numerals refer to similar components:

FIG. 1 illustrates a first embodiment of a mechanical power transfer device; and

FIGS. 2A-D illustrate a second embodiment of a mechanical power transfer device.

### DETAILED DESCRIPTION OF THE PREFERRED EMBODIMENTS

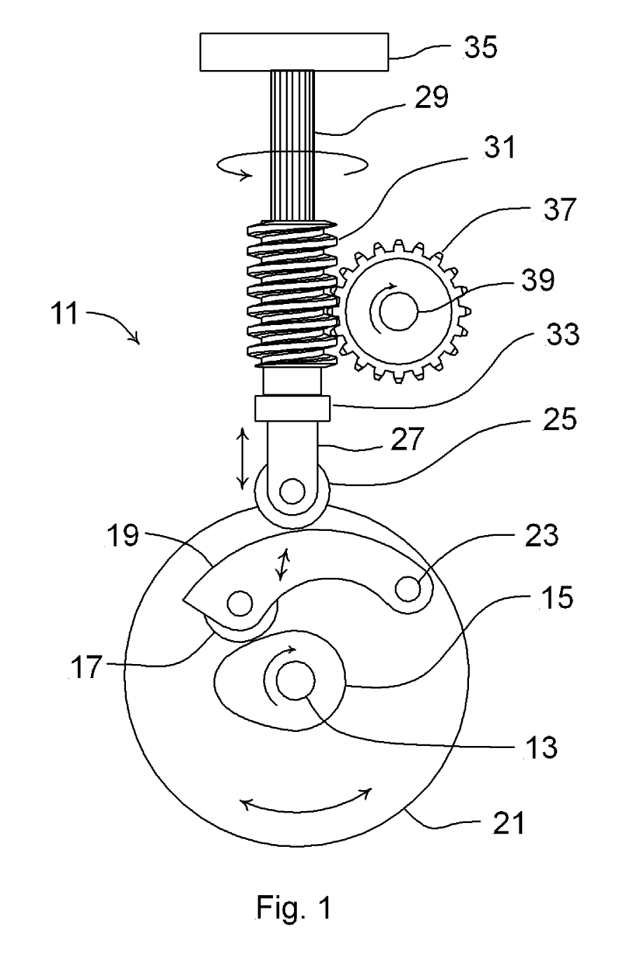

Turning in detail to the drawings, FIG. 1 illustrates the basic design concept of a power transfer device 11. In this device, the cam shaft 13 serves as the drive input and is fitted with a cam lobe 15 which engages a first roller tappet 17 mounted on a rocker arm 19. The rocker arm 19 is mounted to a wheel 21 at a pivot point 23, and the wheel 21 is in turn mounted on and rotationally isolated from the cam shaft 13. The wheel 21 is rotationally isolated from the cam shaft 13 and is rotatable to adjust the relative position of the pivot point 23 with respect to the cam shaft 13. Once the wheel 21 is set at a desired position, it is preferably locked from further unwanted or accidental rotation. This arrangement allows the amount of displacement of the rocker arm 19 to be changed regardless of whether the cam shaft 13 is rotating or stationary.

As the cam lobe 15 rotates and displaces the rocker arm 19, the rocker arm engages a second roller tappet 25, this one being affixed to the support 27 at one end of a splined shaft 29. A worm 31 is fitted to the splined shaft 29. A thrust bearing 33 at one end of the splined shaft 29 cradles the splined shaft 29 and the worm 31, providing a bearing surface between them and the support 27 so that the worm 31 and splined shaft 29 may rotate while the support 27 does not. The end of the splined shaft 29 opposite the thrust bearing 33 is coupled to a coil spring 35. The coil spring 35 is coupled to one of the drive input or the drive output through an appropriate linkage (not shown) which tensions the coil spring 35 during operation.

The worm 31 engages a spur gear 37 which is mounted on the drive output shaft 39. During operation, the worm 31 does not transfer power to the spur gear 37 through rotation. Rather, as the cam lobe 15 rotates on the cam shaft 13, the worm 31 translates in forward and reverse directions, with respect to the spur gear, on the splined shaft 29. As the cam lobe 15 causes forward displacement of the second tappet 25, the worm 31 is translated in the forward direction and engages the spur gear 37. Translation of the worm 31, without rotation, causes the worm 31 and the spur gear 37 to perform as a rack and pinion. As the cam lobe 15 continues to rotate and the tappet displacement rate in the forward direction decreases, the driving pressure between the worm 31 and the spur gear 37 decreases sufficiently to allow the worm 31 to rotate freely of the spur gear 37. When this happens, the tension built up in the coil spring 35 causes the worm 31 to rotate in the reverse direction and translate along the splined shaft 29 to follow the thrust bearing as the second tappet 25 reverses direction and completes a full cycle.

In the above device, for every cycle of the cam lobe 15, the spur gear 37 is rotated by an amount determined by the linear displacement of and the length of the worm 31. During each cycle, the relative translational position of the worm 31, with respect to the spur gear 37, is reset by rotating the worm 31 in the reverse direction. Further, rotation of the worm 31 in the reverse direction is capable of resetting the position of the worm 31 regardless of whether the spur gear 37 remains stationary or continues to rotate in the forward direction during the reset phase of the cycle. In designs where the spur gear continues to rotate in the forward direction, rotation of the worm needs to be performed at a higher rate as compared to designs where the spur gear remains stationary.

Those skilled in the art will appreciate that the transfer ratio of this basic design may be easily decreased by driving the output shaft using multiple worms, two of which may easily interact with a single spur gear, or multiple worms, multiple spur gears, and multiple cam lobes. In fact, a great many possibilities exist for modifications of this basic design to suit different needs. For example, where multiple worms are used, instead of using a coil spring to reset each worm, planetary gears or other similar mechanical dividers might be employed. As another example, a single cam shaft with one or more cams could be used in combination with rocker arms to displace two worms driving the same spur gear. Another aspect that will be appreciated is that the drive ratio, even when a single worm is employed, may be continuously varied, through adjustment of the position of the rocker arm, without the use of any frictional gear interactions within the drive chain.

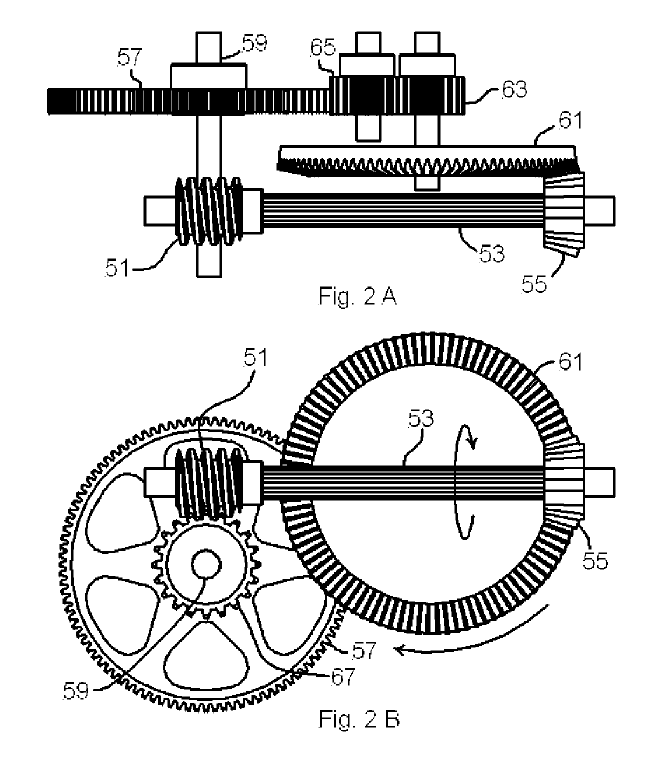

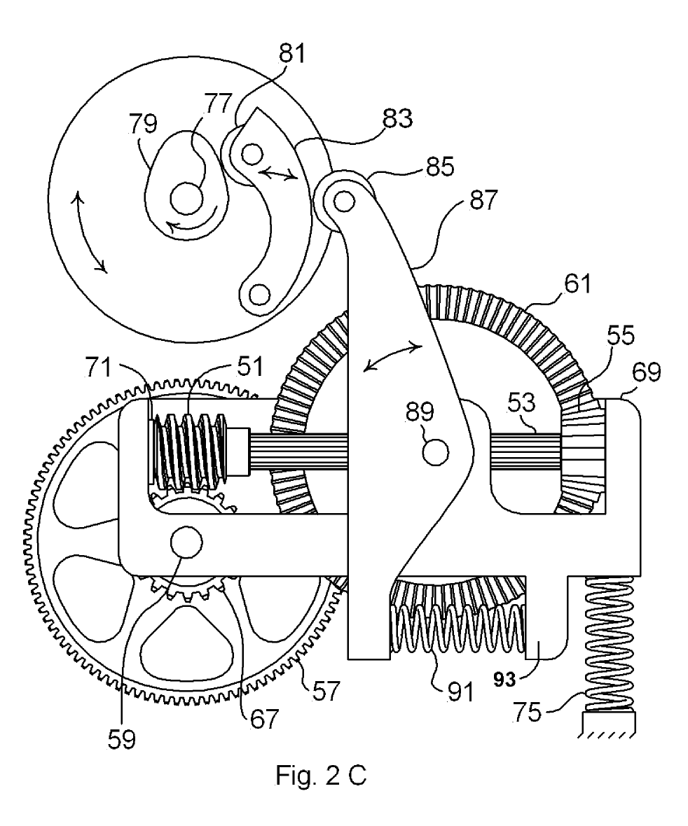

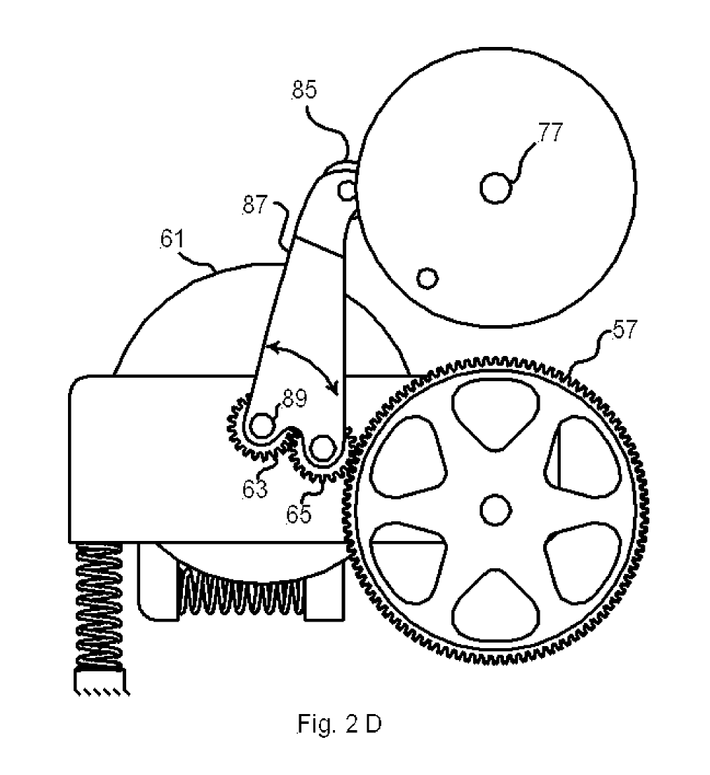

FIGS. 2A-C illustrate an alternative embodiment which uses the same design concept of interaction between the worm and the spur gear. As shown in FIG. 2A, the worm 51 is mounted on a splined shaft 53. The splined shaft 53 is directly coupled to a pinion gear 55, which is in turn rotationally coupled to a large spur gear 57, which is mounted on the driven shaft 59 (the output drive), through a bevel gear 61 and two other coupling gears 63, 65. As shown in FIG. 2B, the worm 51 is coupled to a small spur gear 67, which is also mounted on the driven shaft 59. The gear ratio of the worm 51 is the same as the combined ratio between the pinion gear 55 and the bevel gear 61 and between the large spur gear 57 and the coupling gear 63. By equalizing the gear ratios in this manner, continuous rotation is allowed despite the presence of two separate, but linked, gear arrangements.

FIG. 2C shows additional support structure for the splined shaft 53, along with the mechanism that drives the worm 51. The splined shaft 53 is mounted within a support arm 69. One end of the splined shaft 53 includes a thrust bearing 71, which cradles both the shaft 53 and the worm 51 and provides a bearing surface between them and the support arm 69. The support arm 69 is mounted to and rotates independently of the driven shaft 59. When the support arm 69 is rotated in a clockwise direction the worm 51 abuts against the thrust bearing 71 and causes the small spur gear 67 to rotate in the forward direction. The biasing spring 75 connected to the distal end of the support arm 69 is anchored and biases the support arm 69 toward a neutral position. The support arm 69 is cyclically driven by the cam shaft 77, cam lobe 79, roller tappet 81, and rocker arm 83, which all operate to displace the second roller tappet 85 mounted on the second rocker arm 87. As shown in FIG. 2D, which is a view of the same embodiment from the opposite side of FIG. 2C, this second rocker arm 87 is split, so that it straddles the support, and is connected to a pivot point 89 that is coaxial with the coupling gear 63. The second rocker arm 87 also supports the second coupling gear 65 and extends to engage a driving spring 91, which in turn engages an extension 93 of the support arm 69. The driving spring 91 also serves to ensure that the roller tappet 85 does not lose contact with the first rocker arm 83 as the cam lobe 79 rotates. Through this arrangement, the support arm 69 is driven in reciprocating motion, with the biasing spring 75 opposing the action of the driving spring 91.

During operation, as the cam lobe 79 rotates, the first rocker arm 83 causes the second rocker arm 87 to rotate in the clockwise direction (as seen in FIG. 2C). During this action, the second coupling gear 65 introduces resistance to movement of the second rocker arm 87 as the second coupling gear 65 is lifted between the first coupling gear 63 and the large spur gear 57. Resistance is introduced by the large spur gear 57, which is coupled to the small spur gear 67, which is in turn driven by the worm 51 as a rack and pinion. Similarly, resistance is introduced by the coupling gear 63 that is mechanically coupled to the pinion gear 55, and therefore to the worm 51. This resistance, in combination with the pressure placed on the worm 51 by the thrust bearing 71 as the support arm 69 rotates in the clockwise direction, generates positive torque between the worm 51 and the small spur gear 67 to prevent back drive by the worm 51.

The action of the second rocker arm 87 causes the support arm 69 to rotate in the clockwise direction through the linkage with the spring 91. This causes the pinion gear 55 to rotate about the output shaft 59 at the same rate of rotation as the bevel gear 61. At this point in the cycle, the pinion gear 55 and the bevel gear 61 are rotationally disengaged, i.e., rotation of one does not directly affect rotation of the other, although neither is able to rotate freely of the other as their respective teeth remain interlocked. As the cam lobe 79 continues to rotate, the biasing spring 75 causes the support arm 69 to rotate in the counter clockwise direction and back to the neutral position, thus completing a full cycle. When the pinion gear 55 and the bevel gear 61 rotationally disengage, the worm 51 stops rotating, and rotation of the support arm 69 causes the worm 51 to abut against the thrust bearing 71, thereby causing the worm 51 and the small spur gear 67 to act as a rack and pinion, driving the small spur gear 67 in the forward direction. As the support arm 69 is biased back to the neutral position, the worm 51 slides up the splined shaft 53 away from the thrust bearing 71. At the end of the cycle, the pinion gear 55 and the bevel gear 61 rotationally reengage, thereby rotationally driving the worm 51 in the reverse direction and causing it to return to a position abutting the thrust bearing 71. As with the previous embodiment, many alterations are possible without changing the functional interaction between the worm and the spur gear as described herein.

Thus, a device for transferring mechanical power is disclosed. While embodiments of this invention have been shown and described, it will be apparent to those skilled in the art that many more modifications are possible without departing from the inventive concepts herein. For example, the skilled artisan will recognize that the gear ratios and timing of a power transfer device based upon the concepts described herein will vary based upon the particular design specifications. The invention, therefore, is not to be restricted except in the spirit of the following claims.

What is claimed is:

1. A power coupling device comprising:
a drive input;
a drive output;
a spur gear coupled to one of the drive input and the drive output; and
a worm coupled to the other of the drive input and the drive output, wherein power is transferred between the drive input and the drive output through the spur gear and the worm, and wherein the worm engages the spur gear such that when the worm is rotated, no power is transferred through the worm, and when the worm is translated without rotation, power is transferred through the worm.

2. The power coupling device of claim 1, wherein when the worm is translated without rotation, the worm and the spur gear perform as a rack and pinion.

3. The power coupling device of claim 1, wherein when the worm is translated without rotation, the worm translates to move the spur gear in a forward direction.

4. The power coupling device of claim 1, wherein when the worm is rotated, the worm translates in a reverse direction.

5. The power coupling device of claim 1, further comprising a coupling between the worm and one of the drive output or the drive input, the coupling being adapted to rotate the worm.

6. The power coupling device of claim 5, wherein the coupling is adapted to rotate the worm in a reverse direction at a rate which permits the spur gear to rotate in a forward direction.

7. The power coupling device of claim 5, wherein the coupling is adapted to rotate the worm in a reverse direction at a rate which permits the spur gear to remain stationary.

8. The power coupling device of claim 5, wherein the coupling comprises a coil spring adapted to store power and rotate the worm in a reverse direction upon release.

9. The power coupling device of claim 5, wherein the coupling comprises a first gear;
a second gear adapted to engage the first gear; and
a cam coupled to the second gear, the cam being adapted to cause the second gear to periodically engage the first gear.

10. The power coupling device of claim 1, further comprising means for periodically rotating the worm in a reverse direction.

11. A power coupling device comprising:
a drive input;
a drive output;
a spur gear coupled to one of the drive input and the drive output;
a worm coupled to the other of the drive input and the drive output, wherein power is transferred between the drive input and the drive output through the spur gear and the worm;
a cam adapted to cause the worm and the spur gear to periodically engage; and
a coupling between the worm and one of the drive output or the drive input, the coupling being adapted to rotate the worm, wherein when the worm and the spur gear engage, the worm and the spur gear perform as a rack and pinion to transfer power from the drive input to the drive output, and when the worm and the spur gear disengage, the coupling rotates the worm such that no power is transferred through the worm to the spur gear.

12. The power coupling device of claim 11, wherein the coupling is adapted to rotate the worm in a reverse direction.

13. The power coupling device of claim 12, wherein the coupling is adapted to rotate the worm in the reverse direction at a rate which permits the spur gear to rotate in a forward direction.

14. The power coupling device of claim 12, wherein when the worm is rotated in the reverse direction, the worm translates in a reverse direction.

15. The power coupling device of claim 12, wherein the coupling comprises a coil spring adapted to store power and rotate the worm in the reverse direction upon release.

16. The power coupling device of claim 11, wherein the coupling comprises a first gear; and
a second gear adapted to engage the first gear, wherein the cam is adapted to periodically engage the second gear from the first gear, thereby causing the worm and the spur gear to periodically engage.
